(19) United States
(12) Patent Application Publication
(10) Pub. No.: US 2004/0133874 A1
(43) Pub. Date: Jul. 8, 2004

(54) Computer and control method therefor

(75) Inventor: Joerg Meyer, Langenzenn (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/673,823

(22) Filed: Sep. 30, 2003

Related U.S. Application Data
(63) Continuation of application No. PCT/DE02/01035, filed on Mar. 21, 2002.

(30) Foreign Application Priority Data
Mar. 30, 2001 (DE) 101 158 99.8

(51) Int. Cl. G06F 9/44

(52) U.S. Cl. 717/100

(57) ABSTRACT

A method for controlling a computer, wherein functions executed by the computer and, optionally, parameters, etc., are input via a voice recognition system and are completed with a manual input, preferably a keystroke. A computer system is also provided, which carries out the method and which has a connected display screen for displaying information. A microphone and a manual input provided in a vicinity of the display screen are connected to the computer.

This is a Continuation of International Application PCT/DE02/01035, with an international filing date of Mar. 21, 2002, which was published under PCT Article 21(2) in German, and the disclosure of which is incorporated into this application by reference.

### FIELD OF AND BACKGROUND OF THE INVENTION

The invention relates to a method for controlling a computer, and in particular to a method for controlling a computer when creating a computer program. The invention further relates to a computer system adapted for such a method and having a display screen connected to a computer for displaying information.

Over the last several decades, computers have taken over a wide variety of control tasks. In office applications, too, they have made the work of employees easier. Correspondingly optimized techniques for inputting information into the computers have been developed. In industrial automation systems, display screens provided with a pressure-sensitive foil are frequently used to compare the coordinates of a finger pressure point with overlaid buttons and thereby to determine the function desired. For office applications, the mouse was developed, which works with a rolling ball that can be moved over a tabletop or the like. From the ball movements, the desired coordinates of a cursor element visible on the screen surface are determined, and the cursor element is then used to select and execute functions.

Each technique satisfies the respective special requirements: in very dirty industrial environments, mechanical control elements are dispensed with and virtual buttons are generated instead. In the everyday office environment it is advantageous if one can select functions by navigating with a cursor on likewise virtually overlaid buttons without requiring any knowledge of programming languages. Although the latter technique makes it possible to accomplish a wide variety of data input tasks, including, e.g., creating sophisticated computer drawings, the input speed is limited in principle because the cursor must always be moved across the screen to the corresponding buttons before a function can be executed. Furthermore, the positioning accuracy depends to a large extent on the skill of the individual user. This may play a subordinate role, for example, when drawings are being created, where speed is less important than precision.

In non-graphics applications, however, particularly when creating programs in various programming languages, there is no such justification for a time-consuming input technique. It is important, instead, to put a program sequence or structure of predefined commands and their associated parameters or other data into an electronically storable form. For this purpose, a typewriter keyboard is typically used to enter the program text in alphanumerical form. Here, the time required depends, on the one hand, on the speed of the person using the keyboard and, on the other hand, on the length of the command words to be entered. It is of course possible to divide the labor by having a typist who has the necessary dexterity enter a program. However, this does not allow interactive programming, so that the programmer is reduced to using paper, pencil and eraser to create a program draft and to optimize it.

On the other hand, so-called voice entry of text has also become available in the meantime, where a spoken text is simply converted into a written text. Until now, however, this technique could not be successfully expanded to include interactive functions, which are required to create programs. Especially when so-called ladder diagrams are used to input programs, where an electric analog circuit diagram replaces the digital program sequence, a large number of control commands must be entered instead of a continuous text. This requires the selection as well as the arrangement and linkage of different control elements, which is accomplished by means of successive instructions that the computer has to recognize and execute correctly. Since most of such functions have parameters, it is not normally possible to define a complete statement within which the desired function including the parameters would then have to be found. Rather, especially in the creation of programs, variables are frequently used that relate to the given application, which expands the instruction vocabulary to include almost the entire language vocabulary and more. The correct understanding and the correct processing of functions, parameters, data and variable names in the creation of programs has so far presented an input-related problem, so that the use of slow input means, such as a keyboard and a mouse, have remained indispensable.

### OBJECTS OF THE INVENTION

Based on these drawbacks of the described prior art, object of the invention include optimizing a method for controlling a computer, such that the use of a keyboard and mouse can be dispensed with preferably as completely as possible in the interactive creation of programs, and especially when using a ladder diagram or some other graphic representation.

### SUMMARY OF THE INVENTION

These and other objects are attained by using a voice recognition system to enter functions to be executed by the computer and, optionally, parameters, etc., which are then finalized by a manual entry, preferably a keystroke.

Based on the grammatical structure of all common languages—i.e., subject, predicate and object—the invention reduces the instruction to a computer to execute an action to predicate and object, i.e., command and data or function and parameter. This breakdown of an instruction into grammatical objects is then made reliably intelligible to the computer, e.g, by a keystroke marking the end of the function or the command or predicate and by a keystroke at the end of the parameters, data or objects. Now it is possible to separate commands, particularly function instructions, on the one hand, from data, e.g, variable names, on the other hand, so that the unlimited set of variable names is separated from the limited set of instructions. Thus it is much simpler to assign a command that has been input by voice to a specific function, e.g, by comparing the matches with all the elements of the command vocabulary, than if the vocabulary were unlimited, where such a support would not be possible. This makes it much easier for the computer to understand the commands entered.

It has proven to be advantageous if a different key is provided for ending a function than for ending a parameter, object or the like. This gives the computer additional information and further facilitates the selection of the desired action. By recognizing the basic function to be executed, the computer can detect from the formats provided for the parameters whether the entered text “four,” for example, is to be understood as a number or as text, particularly a variable name or the like. The probability of misinterpretations is thus substantially reduced and—inversely proportional thereto—the working speed is increased.

Additional advantages result if an additional key is pressed, or the function key is pressed again, to end a function provided with a plurality of optional parameters. This method can be used, e.g., to mark the end of a complex command that is provided with optional parameters.

If the keys to be actuated are overlaid on an operator screen by means of a program, the keystroke can be registered, for example, by a pressure sensitive foil applied to the screen. This makes it possible to eliminate control elements in the narrower sense. Furthermore, the screen is indispensable in any case to provide feedback to the information entered and can therefore also be used for operation.

A further feature according to the invention is that selectable objects, functions or parameters are overlaid on an operator screen, and the selection is registered, for example, by a pressure sensitive foil applied to the screen. This option of directly marking, for example, elements used as function objects from a stored library supplements the interactive input, so that e.g, variable names that are difficult to recognize are not selected by voice but by pressing a virtual button associated with the corresponding object. Compared, for example, to manual entry using a typewriter-like keyboard, this has the advantage that the corresponding object can be uniquely identified with a single finger movement to eliminate the risk of typing errors as well as voice recognition errors.

Such a library can be selected and opened, e.g., by an underlying function control of the computer. For example, along a hierarchically organized structure precisely the desired object can then be displayed on screen and specified by tapping. Parameters to be entered can be filtered by determining whether a library control function or the like was entered instead of a parameter. If true, the system goes to a subroutine, which is terminated when an object or parameter to be input is specified by jumping back to the operator level or the input interpretation level. As these explanations show, this input method is particularly suitable for a graphic creation of programs. Individual program segments are stored as objects in a separate library and are linked together by voice until the desired function is realized. This takes into consideration, in particular, the input of a ladder diagram, which through an automatic translation into the machine language is then converted into an executable program that realizes precisely the function of the circuit diagram entered.

It falls within the scope of the invention that the selection of the information to be entered is made by comparing the coordinates of the pressure area with the coordinates of the overlaid keys, objects, functions, parameters, etc. and that the last key, object, etc. selected is processed as information as soon as no further pressure area is detected. This makes it possible to uniquely associate a sensed pressure on the pressure-sensitive foil with exactly one displayed object or the like. An object that the computer detects as being selected is displayed on screen in a different color, for example, or is highlighted by a frame to indicate that the computer considers the corresponding object to have been selected. If the user did not hit the actuatable button, e.g, because of a parallax error in viewing the screen, he or she can find the actuatable button by “feel” without taking the finger off the screen surface and thus knows when letting go of the screen that the computer will use exactly the desired object, which is highlighted by marking, as a function parameter or the like.

A computer system for carrying out the method according to the invention has a display screen connected to the computer to display information and a connected microphone. A manual input means is connected or can be connected in the area of the display screen.

The microphone is indispensable for voice recognition. Connected downstream of the microphone may be an amplifier, a sampling/holding means as well as an analog-to-digital converter and a voice recognition component. The voice recognition component correlates the voice signal with predefined voice patterns to detect the signal content and then converts it into alphanumeric characters that can be processed by the computer in a corresponding (ASCII) coding. In parallel, a manual input means is provided which may take various forms. Feasible, for example, is an element that can be actuated by touch in which a connected oscillating circuit is detuned by the capacitance inherent in the human body, so that the computer can detect the user's action without mechanical control elements. In the broadest sense, a foot pedal with a connected momentary contact switch is also feasible. However, because of the increased effort required to actuate it, such an embodiment is less suitable. This is also true for the verbal input of an “END” word, because the constant repetition of such a word with each command entry would quickly become tedious. A finger-actuated input means has therefore been recognized as optimal.

A microphone that can be coupled with the computer via a serial interface can be connected to any commercially available computer, which can then carry out the method according to the invention after loading a corresponding program. To enable communication with the computer via a serial interface, the microphone housing should simultaneously be equipped, if required, with an amplifier and an analog-to-digital converter. The required supply voltage is provided via the interface.

If the microphone is built into the screen housing, the entire human machine interface can be realized as a single unit with integrated screen and microphone. The additionally required key can likewise be built into the housing or can be displayed as a button on the screen. In this case it has proven to be advantageous if the manual input means is embodied as a pressure-sensitive foil applied to the display screen. Such a pressure-sensitive foil makes it possible not only to realize a single button for identifying the end of commands and parameters but also an interactive input means. Libraries can be graphically displayed, opened and searched until a found object is selected by pressing an area of the pressure-sensitive foil configured as a button.

In a further refinement of the concept according to the invention, the manual input means is configured as an approximately hand-sized mobile unit. Within the scope of such a unit, a conventional momentary contact switch with optional debouncing function can be realized. Such a housing may also be equipped with a touch-sensitive momentary contact switch that responds even to contact without pressure.

The mobile input unit is preferably coupled to the computer with a cable or an infrared interface or some other wireless interface. A (shielded) cable offers the best interference immunity and, at the same time, makes it possible to use the supply voltage of the computer itself. A connector to be connected to the computer can have, for instance, the standard pin assignment of a parallel or serial interface. The corresponding interface can be simultaneously used for voice input if, for example, the different input devices can be distinguished by means of different address assignments. When an infrared interface or some other wireless interface is used, the mobile unit must be equipped with a power source, e.g, in the form of a battery. In this case, the interference susceptibility may be slightly increased. On the other hand, such an instrument may be hand-held mechanically, e.g, like a light ballpoint pen, so that the user is not restricted in his movements while operating it.

Finally, it falls within the teaching of the invention that the microphone is built into the mobile input unit. Because the entry key must always remain within the user's reach, the microphone can be accommodated in the same housing without concern. At the same time, the digitized voice signals and manual input signals can already be combined in this mobile input unit, in which case a suitable interface protocol should optionally be used to ensure that the origin of the signals currently transmitted from the microphone or from the entry key to a computer can be clearly distinguished. In this case a single transmission channel may suffice to transmit all the information to the computer. A receive unit may either be inserted into a separate slot reserved for additional modules on the main board of the corresponding computer, or the receive unit may be configured so that it can be connected to an interface terminal. In the latter case, any conventional office computer can be operated using the method according to the invention without any further modification after a program according to the invention has been loaded into it and the receiver has been plugged into an interface terminal.

### BRIEF DESCRIPTION OF THE DRAWINGS

Other features, details, advantages and effects based on the invention will now be described, by way of example, with reference to a preferred embodiment of the invention depicted in the drawing in which:

FIG. 1 shows a computer workstation according to the invention,

FIG. 2 illustrates various steps for carrying out the method according to the invention,

FIG. 3 illustrates the conversion of the grammatical structure of voice commands into commands that the computer can understand, and

FIG. 4 is a signal flow diagram for carrying out the method according to the invention.

### DETAILED DESCRIPTION OF THE PREFERRED EMBODIMENTS

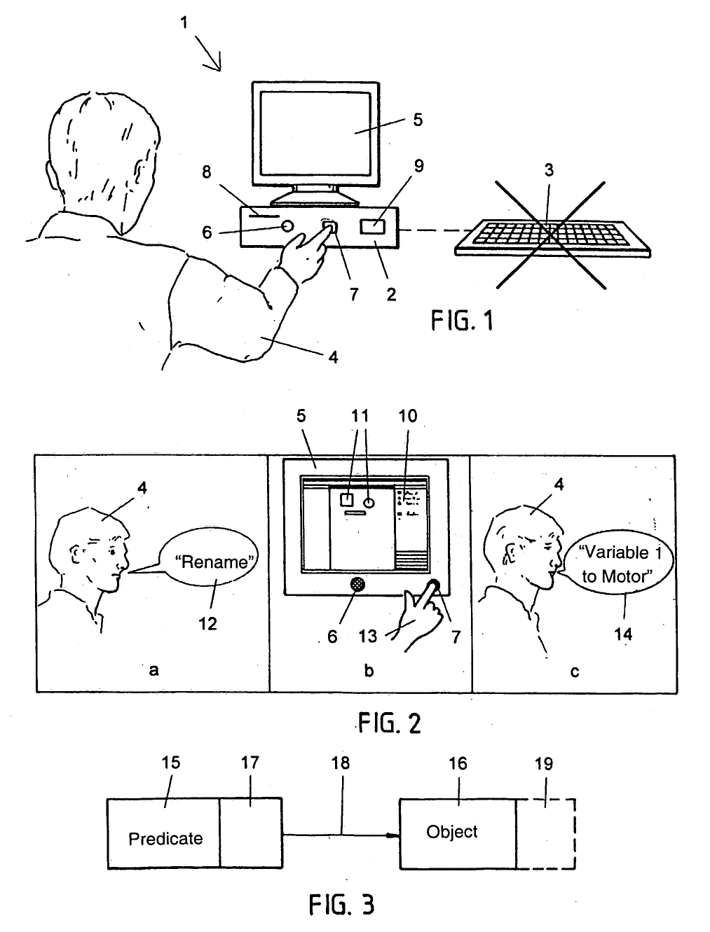

FIG. 1 shows a computer workstation 1 with a computer 2 that can be controlled completely without using a keyboard 3. The user 4 receives visual feedback of the current activity of the computer 2 through a display screen 5 connected to the computer 2. A microphone 6 on the one hand and an entry key 7 on the other serve to control the computer 2. For the further exchange of information with the surrounding environment, the computer 2 may furthermore be conventionally equipped with a diskette and/or a CD drive 8, a loudspeaker 9 as well as control lamps, etc. After an appropriate application program has been loaded by means of the diskette or CD drive 8, the computer 2 can then reliably execute even the most complex functions controlled by voice input.

A corresponding example is given in FIG. 2. This figure illustrates the interactive creation of programs using program components stored in a library 10. These program components are selected to create the program and are displayed as graphic symbols 11 on a background. They are subsequently linked in such a way that, for instance, the input of one graphic symbol 11 is linked to the output of another graphic symbol 11. For this purpose, the interfaces between these individual program segments must be given individual names so that these program components can be used multiple times without the occurrence of misunderstandings. For example, a coupling signal between two graphic symbols, which was automatically assigned, e.g., the variable name of the preceding program component 11 (output name “variable 1”) is given a new characteristic name that better reflects the significance of this signal or the component controlled thereby. In the example shown, the user 4 would like to change the current name “variable 1” to “motor” to indicate that the component controlled by this signal is a motor.

Within the scope of the method according to the invention, this is solved in that the user 4 speaks the command “rename” 12 clearly audibly into the microphone 6 (step a), then presses the entry key 7 manually 13 to indicate that the command 12 has now been entered (step b). The computer 2 can now determine the desired function from the voice entry 12 by comparing it with the complete command set. Once this has been done, the computer 2, based on additional information available regarding this command, detects that this command requires at least two parameters, namely the current name of the component to be renamed and its future name. A format memory may contain the additional information that these two parameters are separated by the spoken word “to.” The computer now waits for the additional voice input 14 at the end of which the entry key 7 is pressed again. When this has been done (step c), the command set “rename: variable 1 to motor” is complete and can be executed by the computer 2. The result, i.e., the name change of a link of two graphic symbols 11, is then displayed on the screen 5.

FIG. 3 shows how the structure of a statement is broken down into the different input elements 6, 7 to enable the many different commands to be communicated to the computer 2 without errors and within the shortest possible time. First, the command set is broken down in accordance with the native grammar (e.g. English, German, etc.) into a predicate 15 (e.g. “rename”) and an object 16 (e.g. “variable 1 to motor”). Then, the predicate 15 characterizing the function of the command set is placed in front of the objects 16 serving as function parameters and is distinguished 17 from these objects with respect to time by actuating the entry key 7. This enables the computer 2, after actuation 17 of the entry key 7, to interpret 18 the speech thus far recorded as a command and to evaluate the further voice input 14, 16 using the format templates stored for this command 12, 15. The parameter input 14, 16, too, is preferably completed by a renewed actuation 19 of the entry key 7. Here, a waiting period could also be required instead, the elapse of which following the last object input 14, 16 would result in an automatic interpretation of the parameters and the subsequent execution of the command thus detected.

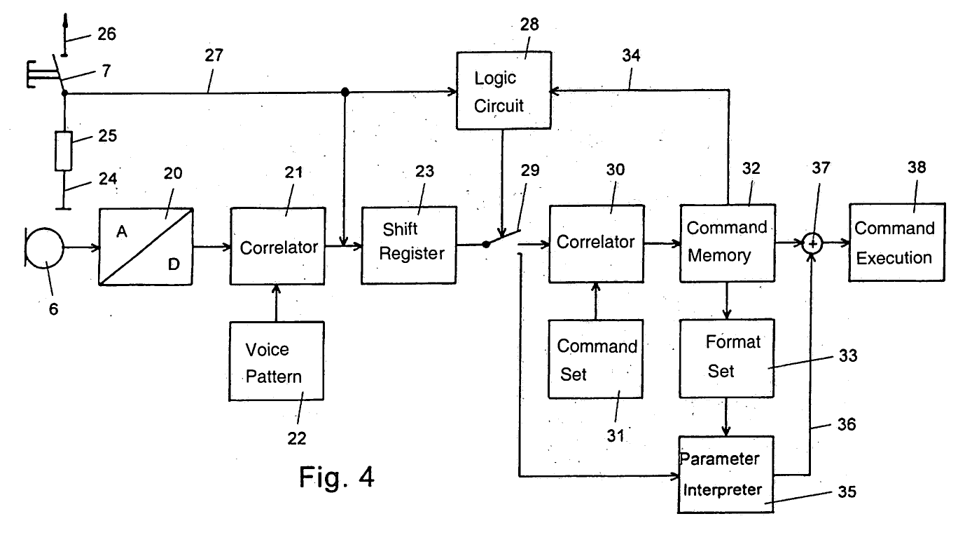

FIG. 4 shows the structure required to control the computer 2. The figure shows the microphone 6 whose output signal, after optional preamplification, sampling with a frequency of e.g, 25 kHz and analog/digital conversion 20, is converted into a series of binary digits corresponding to the individual sampling values. In a downstream correlation component 21 this signal sequence is compared with stored voice patterns 22 to convert the entered speech into a sequence of letters, which is then written into a FIFO memory 23, e.g, of the shift register type. As a result, in the example of FIG. 2, the memory 23 first contains the letter sequence “rename” in ASCII code.

Thereafter, the entry key 7 is actuated 13, 17. This causes the resistor 25 placed at ground potential 24 at one end to be connected to the supply voltage 26 with its other end, so that the common circuit node 27, while the key 7 is being actuated, is at the potential of the supply voltage, preferably at “high level,” while otherwise following the ground potential 24 (preferably “low level”). The key 7 can have a downstream, debouncing logic or differentiation logic to detect the rising and/or falling signal edges. When the entry key 7 is actuated, a special end-of-sequence signal is therefore pushed into the shift register 23 and thus marks the end of the command sequence. At the same time, or delayed by a predefined time interval, a switch 29 at the output of the shift register 23 is closed via a logic circuit 28. As a result the content of the shift register is supplied to a correlation component 30, which compares this text with the limited and stored command set 31 to determine, for example, the start address for the subroutine corresponding to the command and to write it into the command memory 32.

Using the stored address, the command memory 32 can read additional information on the parameters of the recognized command from a format memory 33. First it determines whether this command even requires parameters. If true, an additional control signal 34 instructs the logic circuit 28 to put the changeover switch 29 into its lower position, according to FIG. 4, as soon as the entry key 7 is actuated the next time. As a result, after completion 19 of the following voice input 16, the second key actuation 7 causes the text converted into ASCII characters to be supplied to a parameter interpreter 35, which simultaneously receives the format 33 valid for the expected parameter via the command memory 32. Thus, the parameter interpreter 35 knows how to handle and, in particular, how to format the data received from the shift register 23. A valid parameter set that complies with the format rules 33 is thus present at the output 36 of the parameter interpreter 35 and is combined 37 with the detected command 32 to start the correct program sequence 38 and the transfer of the required parameters 36.

For reasons of clarity, this block diagram does not show the means for the additional specification of objects using a pressure-sensitive foil applied to the screen 5. However, objects thus specified can be supplied directly at the input of the parameter interpreter 35. For this purpose, an OR function would have to be provided between the output signal of the switch 29 and a corresponding detection software for the actuation of buttons.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. Method for controlling a computer to create programs, wherein an instruction to be executed by the computer includes a function and parameters, and wherein a voice recognition system for verbal input of the function and parameters of each instruction and at least one manual input for acknowledgments to the computer are provided, the method comprising:
entering the function of the instruction as a verbal input via the voice recognition system,
acknowledging the verbal input of the function of the instruction via the manual input, and
entering the parameters of the instruction as a further verbal input via the voice recognition system.

2. Method as claimed in claim 1 further comprising acknowledging the further verbal input of the parameters of the instruction by an additional manual input.

3. Method as claimed in claim 2, wherein separate function and parameter keys for the manual input are provided to acknowledge the verbal input of the function and to acknowledge the further verbal input of the parameters, respectively.

4. Method as claimed in claim 3, wherein an additional key is provided to acknowledge the verbal input of a plurality of the parameters.

5. Method as claimed in claim 3, further comprising pressing the function key a further time to acknowledge the verbal input of a plurality of parameters.

6. Method as claimed in claim 1, wherein an operator screen is provided that overlays keys for the manual input utilizing a software program.

7. Method as claimed in claim 1, further comprising overlaying at least one of stored functions and stored parameters for selection on an operator screen.

8. Computer system comprising:
a computer;
a display screen connected to the computer to display information,
a microphone connected to the computer, and
a manual input provided at least in a vicinity of the display screen and connected to the computer,
wherein the computer is configured to receive and process a function of an instruction as a verbal input via the microphone, receive and process an acknowledgment of the verbal input of the function of the instruction via the manual input, and receive and process the parameters of the instruction as a further verbal input via the microphone.

9. Computer system as claimed in claim 8, wherein the display screen comprises a housing into which the microphone is incorporated.

10. Computer system as claimed in claim 8, wherein the manual input comprises a pressure sensitive foil applied to the display screen.

11. Computer system as claimed in claim 8, wherein the manual input comprises a manually operable mobile input unit.

12. Computer system as claimed in claim 11, wherein the mobile input unit is coupled with the computer via a cable.

13. Computer system as claimed in claim 11, wherein the mobile input unit is coupled with the computer via a wireless interface.

14. Computer system as claimed in claim 13, wherein the mobile input unit is coupled with the computer via an infrared interface.

15. Computer system as claimed in claim 11, wherein the microphone is incorporated into the mobile input unit.
